(19) United States
(12) Patent Application Publication
(10) Pub. No.: US 2025/0388036 A1
(43) Pub. Date: Dec. 25, 2025

(54) CONTAMINATION PREVENTION DEVICE FOR INKJET PRINTING SYSTEM AND METHODS THEREOF

(71) Applicant: XEROX CORPORATION, NORWALK, CT (US)

(72) Inventors: Jorge A. Alvarez, Webster, NY (US); Varun Sambhy, Pittsford, NY (US); Seemit Praharaj, Webster, NY (US); Anthony S. Condello, Webster, NY (US); Jason M. LeFevre, Penfield, NY (US); Douglas K. Herrmann, Webster, NY (US); Christine A. Steurrys, Williamson, NY (US); Brian Lindstrom, Victor, NY (US); Peter M. Gulvin, Webster, NY (US); Mark C. Petropoulos, Webster, NY (US); Palghat S. Ramesh, Pittsford, NY (US)

(73) Assignee: XEROX CORPORATION, NORWALK, CT (US)

(21) Appl. No.: 18/749,256

(22) Filed: Jun. 20, 2024

(51) Int. Cl. B41J 29/17; B08B 1/16; B08B 1/20; B41J 11/00

(52) U.S. Cl. CPC B41J 29/17; B08B 1/165; B08B 1/20; B41J 11/0015; B41P 2235/21

(57) ABSTRACT

A printhead contamination prevention device is disclosed. The printhead contamination prevention device includes a mounting fixture, optionally rotatable to multiple angles about a central axis, and an optionally movable blade attached to the mounting fixture, where an angle of the mounting fixture and a position of the movable blade create a gap between a tip of the movable blade and a printing media. An angle of the movable blade relative to the printing media is from about 15 degrees to about 35 degrees and a gap between the tip of the blade and the printing media is from about 0.1 mm to about 0.75 mm. A method for preventing contamination in a printing system by blocking one or more droplets of a non-pigmented fluid ejected from the primer dispensing printhead that are not coated onto the surface of the media from moving along the media path is disclosed.

### TECHNICAL FIELD

The present teachings relate generally to inkjet printing systems with precoat systems and, more particularly, to contamination prevention devices for inkjet printing systems with precoat systems.

### BACKGROUND

Digital aqueous ink jet (AIJ) printing is an area of growth for several production class printing systems. Printers or consumers of printed materials making or considering a transition from a dry powder (electrophotographic) printing system to an acoustic ink jet printing system or printing press require the maintenance of existing image quality (IQ) and print permanence and durability characteristics while reducing run cost per kiloprint (kp). Exemplary printing systems using the aqueous ink jet printing methods have significantly improved print image quality matching or exceeding current electrophotographic printing methods.

The image quality of aqueous ink images printed onto various types of media varies according to the type of media being printed. Image quality is typically exemplary when the aqueous ink is printed onto offset coated, non-glossy media because the ink remains on top of the coating. Aqueous ink printing onto uncoated, porous media, however, produces washed out, poorer quality images because the inks are absorbed into the fibers of the paper. To avoid this consequence, coatings can be applied to porous media to reduce the absorption of the inks into the media. Primers, also known as precoat solutions, reduce the interaction of the inks with the media since the primer is interposed between the media and the inks. Because the ink image is fixed to the primer layer rather than the media, the ink image can be more easily removed. The ease of ink image removal from media is a significant factor in recycling printed media. In some instances, the precoat solution could unintentionally be transferred to another location within the printing system, where contact between the precoat solution and ink would cause problematic interactions.

Therefore, it is desirable to develop or design methods or systems to improve image quality, gamut, and deinkability of AIJ prints on uncoated media, while limiting exposure to other areas of the printer or printing system where disadvantageous interactions can occur.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A printhead contamination prevention device is disclosed. The printhead contamination prevention device includes a mounting fixture, rotatable to multiple angles about a central axis, and a movable blade attached to the mounting fixture, where an angle of the mounting fixture and a position of the blade create a gap between a tip of the blade and a printing media. Implementations of the printhead contamination prevention device include where the printhead contamination prevention device is located between a primer dispensing system and at least one ink jetting printhead. The primer dispensing system may include a printhead and a movable blade. The printhead contamination prevention device may be in proximity to four ink jetting printheads. A primer composition dispensed by the primer dispensing system may include about 5% wt to about 40% wt of a salt in an aqueous solution based on a total weight of the aqueous solution. An angle of the movable blade relative to the printing media is from about 15 degrees to about 35 degrees. A thickness of the movable blade is from about 0.5 mm to about 1.5 mm. The gap between the tip of the blade and the printing media is from about 0.1 mm to about 0.75 mm. The printing media is paper and the blade is configured for linear translation along a side of the mounting fixture. Implementations of the described techniques may include hardware, a method or process, or computer software on a computer-accessible medium.

Another printhead contamination prevention device is disclosed, including a mounting fixture, rotatable to multiple angles about a central axis, and a movable and deformable blade attached to the mounting fixture, and where the movable blade is in contact with a printing media when the printing media passes below the printhead contamination prevention device. Implementations of the printhead contamination prevention device can include where the printhead contamination prevention device is located between a primer dispensing printhead and at least one ink jetting printhead. A primer composition dispensed by the primer dispensing system may include about 5% wt to about 40% wt of a salt in an aqueous solution based on a total weight of the aqueous solution. An angle of the movable blade relative to the printing media is from about 15 degrees to about 35 degrees. A tip of the movable blade contacts the printing media.

A method for preventing contamination in a printing system is disclosed. The method for preventing contamination in a printing system includes coating a non-pigmented fluid on at least a portion of a surface of a media with a primer dispensing printhead, transporting the coated media along a media path, placing a printhead contamination prevention device may include an edge that spans across an entire width of the media path in proximity to the surface of the media, and forming a gap between the edge of the printhead contamination prevention device and the surface of the media. The method includes blocking one or more droplets of non-pigmented fluid ejected from the primer dispensing printhead that are not coated onto the surface of the media from moving along the media path. Implementations of the method for preventing contamination in a printing system include where the edge of the printhead contamination prevention device may include a non-continuous edge. The method for preventing contamination in a printing system may include adjusting the gap between the surface of the media and the edge of the contamination prevention device.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic diagram of a system and method for pre-coating paper prior to ink jet printing, in accordance with the present disclosure.

FIG. 2 is a schematic of a contamination prevention device, in accordance with the present disclosure.

FIG. 3 is a schematic of a contamination prevention device, in accordance with the present disclosure.

FIG. 4 is a schematic of a contamination prevention device, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The apparatus and methods of the present disclosure solves the problem of preventing contamination of other ink-dispensing printheads while depositing of primer or pre-coat solution in an aqueous ink jet printing system, where primer or precoat is used to improve print quality and de-inkability in production ink jet printing presses. Stray droplets or mist can be carried away by the airflow produced by the media or the media transport subsystems from the first print head to the next print heads. These droplets containing pre-treatment or primer could land in the vicinity of the nozzles of the downstream print heads. Pre-treatment droplets contacting of the inks can interact and cause the pigment to crash out of the ink solution while still in the nozzle. This repeated action of contamination of the downstream print heads can create deposits of pigment on the nozzle that will eventually clog the contaminated nozzle.

Inks and media come in an ever-widening array of chemical and physical combinations. What may work well, in terms of printing parameters and materials, on glossy coated media may fail or exhibit poor quality on porous uncoated stock.

To address this issue, a method and system are proposed to utilize a contamination prevention device to prevent contamination from the deposition of a precoat solution from negatively impacting the operation of one or more ink-dispensing printheads. The precoat solution, also referred to as a precoat composition, precoat, primer, or primer solution, can include an aqueous salt solution that improves ink adhesion and de-inkability by “crashing” or precipitating the ink pigment portion of the ink composition and preventing it from sinking or diffusing into the bulk of the paper. As used herein, the term “primer” or “precoat” can be defined as coatings or solutions that are applied to media to improve the image quality of the ink images over that which is achieved without the coatings. The use of a salt solution as a precoat solution has several advantages, including low material cost and the ability to improve print quality on both coated and uncoated paper. The effect of “crashing,” precipitating, or causing the precipitation of a component of an ink can include any single chemical or combination of chemicals in relation to a printed ink or other printing related fluid that can facilitate the desolubilization or precipitation of one or more components in the ink. The desolubilizing can be accomplished by proton transfer from collision or close proximity of a crashing agent with one or more of the ink components. The desolubilizing can be caused by component associations induced by a combination of a precoat solution and/or component associations occurring with the precoat solution. In alternate examples, salt-based primer formulations may not be used, but may comprise one or more clear, colorless, jettable fluids that incorporates an active ingredient that when the primer is in contact with or combined with one or more aqueous based inks, will result in a “crash” or desolubilization the aqueous ink formulation similarly to how salt-based primers function.

The mechanism by which the precoat solution crashes or causes the precipitation of the ink pigments at the surface is alternatively reasoned to be via the breaking of the surface tension of the ink which causes the pigments, dyes, or other components to precipitate and adhere to the surface of the paper. The use of an inkjet print head to deposit a primer solution provides a uniform and consistent coating of the solution on the paper, thus ensuring that the solution sufficiently covers all areas of the paper. This precoat solution, or primer dispensing printhead can aspirate or cause the presence of airborne droplets of precoat/primer solution or ingredients.

It is also expected that the thin primer layer works to normalize the interactions between the ink and media. The ink only comes in contact with the primer during intended use, therefore regardless of the media underlayer, the image on the top will essentially appear the same. It is understood that there may still exist some unique gloss effects resulting from underlying media smoothness. Although the application of primers in printing systems of some compositions is known, a system of the present disclosure includes where one or more printheads are used to deposit a fluid on the media with the purpose of applying a primer, followed by printheads that deposit ink of fluid type to mark images on the media soon after the first fluid is deposited. In a such system, if the first fluid reaches the next set of printheads, it could incur damage to the printhead and induce premature clogged or missing jets. The primer fluid tends to reduce the mobility of the pigment while the ink is still in a wet state. The present disclosure describes a device that minimizes the contamination of the printheads jetting the inks on the media.

A printing system of the present disclosure applies a precoat solution to the surface of the media to promote the pigment in the inks to affix near the top of the treated surface to enhance the resulting image quality or the color gamut relies on the chemistry of the treatment to reduce the pigment mobility or spread once the ink reaches the surface of the media. This pigment migration or mobility under normal conditions can be lateral or into the paper fibers. In an aqueous ink embodiment where inks contain a large water content, the water wets the surface of the media and carries the pigmented particles with it. The precoating treatment of the media minimizes the pigment migration, mobility, or spread allowing it to remain closer to where the ink drops land. Moreover, it is understood that inks printed along with a primer or precoat solution would be more suitable for deinking when the media is pre-treated prior to printing.

When used in a printing system that uses a print head to jet or deposit the primer and the print head is placed in proximity to the print head that jet pigmented inks, stray droplets or mist can be carried away by the airflow produced by the media or the media transport subsystems from the first print head to the next print heads. These droplets containing pre-treatment (primer) have the potential to land in the vicinity of the nozzles of the downstream print heads. Pre-treatment droplets contacting any inks can interact and cause the pigment to crash out of the ink solution while still in the nozzle. This repeated action of contamination of the downstream print heads will create deposits of pigment on the nozzle that will eventually clog the contaminated nozzle. This can initiate service actions and most likely print head replacements incurring a higher cost of operation.

Unfortunately, the same mechanism that causes the ink pigment to “crash” on the sheet when reacting to the pre-treat, which is a desired result, could cause the ink to “crash” in the printheads. If even small amounts of the pre-treat should become airborne and contact the printhead near the nozzles, or if a pre-treated sheet, with the pre-treat not yet dry, should contact the printhead, it could cause the pigment in the ink to “crash” in the nozzles. If the ink pigment “crashes” in the printheads, it can cause catastrophic damage to the printheads likely resulting in a head replacement.

A printhead contamination prevention device of the present disclosure can be placed between a primer dispensing system and at least one ink jetting printhead to prevent contamination from reaching the ink jetting printhead, which can cause damage or clogging of the printheads and result in decreased printing quality or even complete system failure. In example systems of the present disclosure, printing media can be paper or any other suitable material for optimal results. The blade is also movable along the side of the mounting fixture to ensure that it covers the appropriate areas, creates an effective gap to prevent downstream primer contamination, and prevents contamination from reaching any of the ink jetting printheads. The blade and the mounting fixture are configured for linear translation of the blade or blades along a side of the mounting fixture. The linear translation of one or more blades along a mounting fixture can be used in combination with, or as an alternative to rotation of the mounting fixture to prevent contamination of primer onto one or more ink jetting printheads in the printing system. The translation mechanism can be or include a sliding mechanism, may include a recessed groove and fastener for the blade to be attached to the mounting fixture, and can be indexed along a side of the mounting fixture prior to or during printing operations. Alternatively, the mounting fixture may be affixed or mounted in such a manner that the entire contamination prevention device is rotatable, translatable linearly, adjustable in a cross-media path translational or rotatable manner, or a combination thereof. Movement of the blade or mounting fixture can be accomplished manually or actuated by a motor with controller by the printing system. The described means of linear translation or articulation should be known to one skilled in the art.

The present disclosure provides a system that will seal and prevent droplets originating at the print head jetting primer from reaching the print heads that are jetting inks containing colored pigments. Several implementations are described herein, one including a blade seal that prevents the airflow from reaching downstream. Such a blade seal provides a physical barrier to disrupt the path of any stray droplets. While there are several implementations described, one example works at a small gap from the media, of approximately 0.25 mm. This implementation includes a non-contact blade. An additional implementation works in a manner where the blade is in contact with the media, where the length, thickness, working angle, interference, the blade material durometer, and other parameters to achieve maximum air flow closure without adding drag on the media to alter its speed parameters. Still another implementation can include a multiblade assembly that is rotatable at a determined life to maintain airflow closure should the blade take a permanent set or deformation. In other examples, one or more brushes can be used in place or the blades mentioned herein, having a similar width and length as the described blades. In an example of a brush, the incorporation of a sufficient density of or a plurality of fibers affixed within an edge of the brush, positioned across a width of the media path can provide a blocking of air flow between a primer dispensing printhead and an ink dispensing printhead. In examples, such as the brush, or in other implementations, a tip of the blade or brush or other implement can include a non-continuous edge, while the blade or brush traverses an entire width of the media path and wherein at least a portion of an edge of the blade is non-continuous. In examples, the non-continuous edge can be at staggered or irregular intervals across a width of the non-continuous blade. In examples, any of the aforementioned blade edges, brushes or non-continuous edges need not be perpendicular or have a consistent gap distance across a media path, which can also be referred to as perpendicular to the process direction. In examples, such an arrangement can provide directed airflow towards one edge of the media path as compared to another.

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

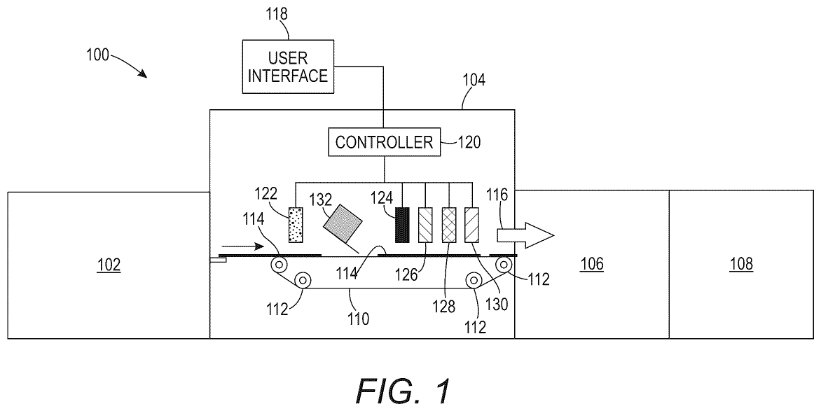

FIG. 1 is a schematic diagram of a system and method for pre-coating paper prior to ink jet printing, in accordance with the present disclosure. The system and method for pre-coating paper prior to ink jet printing can be integrated in entirety, or in part, into a high-speed color inkjet printer 100. The system and method of the present disclosure includes a method of preventing contamination in printheads. FIG. 1 depicts a high-speed color inkjet printer 100 that uses a primer measuring method in conjunction with a diagnostic sheet to identify accurately the location of precoat solution or primer applied to media in the printer to enable media to be treated with primers effectively and efficiently. More specifically, the primer measuring method and diagnostic sheet can provide an indication of missing locations of application of precoat solution. As illustrated, the printer 100 is a printer that directly forms an ink image on a surface of a media sheet stripped from one of the supplies of media sheets stored within a paper feeder 102 and the sheets are moved through the printer 100 in a process direction 116 by a controller 120 operating one or more of the actuators that are operatively connected to rollers or to at least one driving roller of conveyor that comprise a portion of the media transport 110 that passes through the print engine module 104 of the printer. In one example, each printhead module has only one printhead that has a width that corresponds to a width of the widest media in the cross-process direction that can be printed by the printer. In other examples, the printhead modules have a plurality of printheads with each printhead having a width that is less than a width of the widest media in the cross-process direction that the printer can print. In these modules, the printheads are arranged in an array of staggered printheads or a linear array of printheads that abut one another to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 100 is depicted with only two supplies of media sheets, the printer can be configured with three or more sheet supplies, each containing a different type or size of media.

With further reference to FIG. 1, the printed image exits the print engine module 104 having a print zone of printer 100 and passes under one or more image dryers 106 after the ink image is printed on a sheet, represented herein as a more generic media 114. As used in this document, the term “print zone” means an area of a media transport opposite the printheads of an inkjet printer. The image dryer 106 can include an infrared heater, a heated air blower, air returns, or combinations of these components to heat the ink image and at least partially fix an ink image to the sheet. An infrared heater applies infrared heat to the printed image on the surface of the sheet to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer. In normal printing operations, the media 114 or sheet is jetted upon with ink or primer or precoat solution in an imagewise fashion and transported through the print zone to create a multicolor image.

Prior to reaching the print zone, the media 114 passes beneath a primer application module 122. The primer application module 122 includes one or more printheads configured as described previously. In the implementation shown, there are four ink jetting printheads, but other systems may include more or less ink jetting printheads. These printheads ejected drops of primer onto the media prior to the media being printed by the printhead modules 124, 126, 128, and 130. The location and presence of primer applied to the media 114 is measured by a detector. In examples, the detector can be inline and positioned within the printing system 100 or can be external to the printer 100, such that a diagnostic sheet can be evaluated offline. The signal generated by the detector can be a visual signal, perceptible by an operator, or provided to the controller 120 via an inline scanner, image analysis or detector. The controller 120 is configured with programmed instructions stored in non-transitory, computer readable media that when executed cause the controller to identify the amount and thickness of primer on the media and adjust the operation of the primer application module 122 to correct the application of the primer for the type of media being printed in normal operation, or indicate a need for a manual operation or intervention by a machine operator. The mechanism of the diagnostic sheet is described in further detail herein.

In examples of a printer 100 as shown and described herein, a return path for printing duplex, or two-sided images can be employed, as well as an accompanying duplex path and controller instructions as needed. FIG. 1 also shows the printed sheets or diagnostic media as being collected in the output module 108, but in examples, they can be directed to other processing stations (not shown) that perform tasks such as folding, collating, binding, and stapling of the media sheets.

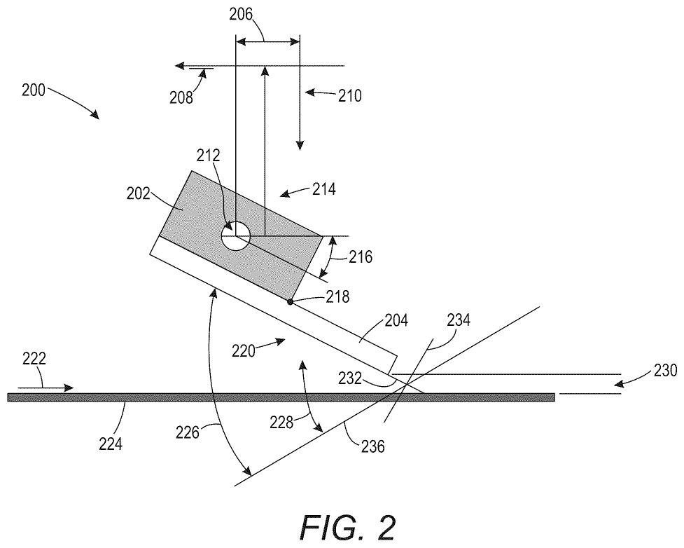

Operation and control of the various subsystems, components and functions of the machine or printer 100 are performed with the aid of a controller or electronic subsystem (ESS) 120. The ESS or controller 120 is operatively connected to the components of the printhead modules 122, 124, 126, 128, and 130 (and thus the printheads), the detector, the image dryer 106, output module 108 and other system components not necessarily shown herein for purposes of clarity. The ESS or controller 120, for example, is a self-contained computer having a central processor unit (CPU) with electronic data storage, and a display or user interface (UI) 118. The ESS or controller 120, for example, includes a sensor input and control circuit as well as a pixel placement and control circuit. In addition, the controller 120 reads, captures, prepares, and manages the image data flow between image input sources, such as a scanning system or an online or a work station connection (not shown), and the printhead modules 122, 124, 126, 128, and 130. As such, the ESS or controller 120 is the main multi-tasking processor for operating and controlling all of the other machine subsystems and functions, including the printing process. Also shown in the printer 100 located between the primer application module 122 and the ink-dispensing printhead modules 124, 126, 128, and 130 is a contamination prevention device 132, which will be described in further detail later with regard to FIGS. 2, 3, and 4.

The controller 120 can be implemented with general or specialized programmable processors that execute programmed instructions. The instructions and data required to perform the programmed functions can be stored in non-transitory, computer readable medium associated with the processors or controllers. The processors, their memories, and interface circuitry configure the controllers to perform the operations described below when the programmed instructions are executed. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 120 from either a scanning system or an online or work station connection for processing and generation of the printhead control signals output to the printhead modules 122, 124, 126, 128, and 130. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

In examples of the present disclosure, the diagnostic system for measuring inkjet printing system performance can include at least one printhead, configured to deposit a precoat solution or primer, a diagnostic sheet, comprising a substrate having a first surface and a second surface, and a layer of material disposed on the first surface of the substrate, wherein the layer of material is color responsive to the precoat solution, and an image scanner configured to capture a color pattern on a surface of the diagnostic sheet after the precoat solution is deposited on the layer of material disposed on the first surface of the substrate. In examples, the precoat solution or primer composition can include from about 5% wt to about 40% wt of a salt in an aqueous solution based on a total weight of the aqueous solution, as well as other compositional parameters or ingredients as described herein.

FIG. 2 is a schematic of a contamination prevention device, in accordance with the present disclosure. A side-view of a contamination prevention device 200 is shown, having a blade holder 202, with a blade 204 attached thereto. The blade 204 is movable and deformable in order to provide an effective seal between a primer dispensing printhead and one or more ink jetting printheads. The blade holder 202 is configured to be pivotable, or rotatable to multiple angles, about a pivot point 212 and in a pivot range 216 ¢ of from about 15 to 35 degrees. Several dimensional indicators also represent a range for movement or adjustment of the contamination prevention device 200, centered around the pivot point 212, including the x-pivot range 206, possible movement in a positive x-direction 208 movement in a positive y-direction 210, and a y-pivot range 214. Also indicated are points on the contamination prevention device 200 showing a top of blade holder end 218, a position of a top of blade at end of holder 220, a media path direction 222 of a media path 224. Additional adjustment points of the contamination prevention device 200 include a blade holder angle 226 (BHA), a blade holder working angle 228, and an effective working gap 230. A tangent line 232 indicating the blade tip and a perpendicular 234 line to the tangent line 232 are also shown. Also shown is a tangent 236 intersecting where an end of blade 204 would contact the media path 224 if actually in contact. In this implementation, the blade 204 can be pivoted such that the contamination prevention device 200 provides a working gap of from about 0.1 mm to about 0.75 mm, without contacting the media or any belt or component in the media path 224. As the blade 204 spans the width of the media path 224, maintaining a minimal gap can reduce or prevent primer or precoat solution that may be aspirated or airborne from traversing past the contamination prevention device 200 and into areas of the printing system occupied by the ink delivery printheads. In examples of the present disclosure, the deflection or position of a blade 204 held in a blade holder 202 or mounting fixture of this and other examples herein may be fixed or rigid and still positioned to prevent contamination along the media path 224 and into one or more printheads in the printing system, while the print media is in motion along the media path. Furthermore, it should be noted that the edge of the blade or other implement at the edge of the contamination prevention device is configured to maintain the gap between the edge and the media when the media is in motion or when the media is not in motion.

The mounting fixture or blade holder 202 provides rotational capability about a central axis. This allows for adjustment of the angle at which the movable blade 204 comes into contact with printing media, creating a gap 230 between the tip of the blade 204 and the surface to prevent contamination from reaching any of the ink jetting printheads. The angle should be within an effective range to create a gap between the blade and media for preventing contamination. In examples, the blade 204 can translate along the mounting fixture or blade holder 202 to extend a length of the blade as it wears or if adjustment is needed. Implementations of the contamination prevention device 200 include a blade free length, from the end of the top of blade holder end 218 to the tip of the blade 204 of from about 4.0 mm to about 14.0 mm. Blade 204 thickness is from about 0.5 mm to about 1.5 mm, and a bending modulus, E, of from about 5,000 g/mm² to about 13,000 g/mm².

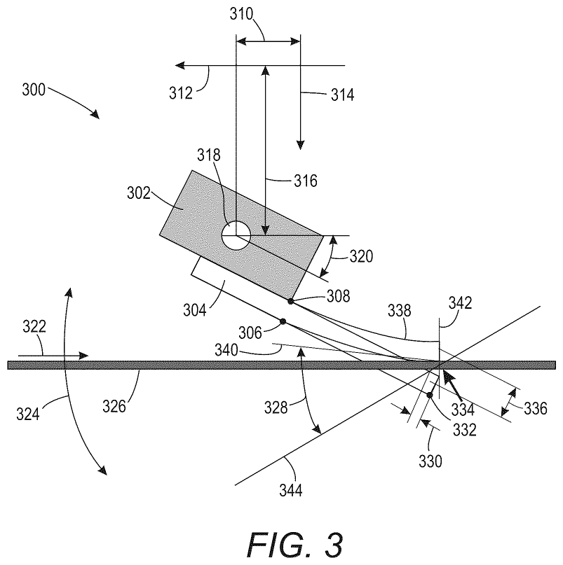

FIG. 3 is a schematic of a contamination prevention device, in accordance with the present disclosure. A side-view of a contamination prevention device 300 is shown, having a blade holder 302, with a blade 304 attached thereto. The blade holder 302 is configured to be pivotable, about a pivot point 318 and in a pivot range 320 ¢ of from about 15 to 35 degrees. Several dimensional indicators also represent a range for movement or adjustment of the contamination prevention device 300, centered around the pivot point 318, including the x-pivot range 310, possible movement in a positive x-direction 312 movement in a positive y-direction 314, and a y-pivot range 316. Also indicated are points on the contamination prevention device 300 showing a top of blade holder end 308, a position of a top of blade at end of holder 306, a top of deflected blade 338, and a media path direction 322 of a media path 326 in contact with blade seal. Additional adjustment points of the contamination prevention device 300 include a blade holder angle 324 (BHA), and a blade holder working angle 328. A tangent line 340 indicating the blade tip and a perpendicular 340 line to the tangent line 342 are also shown. Also shown is a tangent 344 intersecting where end of blade 304 contacts the media path 326. In this implementation, the blade 304 can be pivoted such that the contamination prevention device 300 contacts the media or any belt or component in the media path 326. As the blade 304 spans the width of the media path 326, maintaining contact with the media can reduce or prevent primer or precoat solution that may be aspirated or airborne from traversing past the contamination prevention device 300 and into areas of the printing system occupied by the ink delivery printheads.

Implementations of the contamination prevention device 300 shown in FIG. 3 include a blade holder angle 324 (BHA) of from about 15 degrees to about 35 degrees, a blade free length from the end of the top of blade holder end 308 to the tip of the blade 304 of from about 4.0 mm to about 14.0 mm. Free length can also be considered as the linear distance between point 306 and point 332 in FIG. 3. Blade 304 thickness is from about 0.5 mm to about 1.5 mm, and an optimal range of normal force, Fn, on to the media by the deflected blade at blade load point 334, nominally 2 g/cm or in a range of from about 0 g/cm to about 20 g/cm. When the blade of the contamination prevention device 300 is deployed, an apparent shortening of blade length 330 is indicated, with a y-max 336 position of deflection. Also shown is a theoretical tip location on the undeflected blade 332.

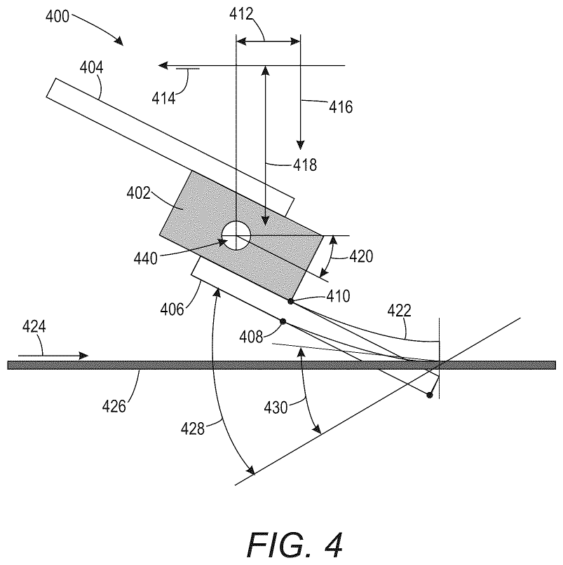

FIG. 4 is a schematic of a contamination prevention device, in accordance with the present disclosure. A side-view of a contamination prevention device 400 is shown, having a blade holder 402, with a blade 406 attached thereto. Indications of a top of the blade holder end 410 and a top of blade at end of holder 408 are shown. The blade holder 402 is configured to be pivotable, about a pivot point 440 and in a pivot range 420 ϕ of from about 15 to 35 degrees. This depiction of the contamination prevention device 400 is similar to the implementation shown in FIG. 3, but includes a second blade 404, mounted on an opposite side of the blade holder 402. Also shown are an x-pivot range 420 a range of travel in the positive x-direction 414, a range of travel for the blade holder 402 in the positive y-direction 406, and a y-pivot range 418. Adjustments and parameters of the contamination prevention device 400 of FIG. 4 are similar to those described in regard to the device 300 of FIG. 3, including the parameters of the second blade 404, when the blade holder 402 is rotated to utilize the second blade 404. For example, the blade 406 or second blade 404 can be pivoted such that the contamination prevention device 400 contacts the media or any belt or component in the media path 426. As the blade 404, 406 spans the width of the media path 426, which travels in media path direction 424, it maintains contact with the media which can reduce or prevent primer or precoat solution that may be aspirated or airborne from traversing past the contamination prevention device 400 and into areas of the printing system occupied by the ink delivery printheads. Additional adjustment points of the contamination prevention device 400 include a blade holder angle 428 (BHA), and a blade holder working angle 430. A tangent line 340 indicating the blade tip and a perpendicular 340 line to the tangent line 342 are also shown. A top of the deflected blade 422 is also shown in engagement position. Alternatives to using a single movable and deformable blade along the side of the mounting fixture includes a device having multiple blades. Using two movable and deformable blades attached to the mounting fixture as shown in FIG. 4 differs from using a single blade in that it provides facile rotation to another blade if a first blade becomes worn or damaged. Multiple movable and deformable blades can be attached to the mounting fixture. For example, three, four five, or as many as six blades can be attached to the mounting fixture and used for preventing contamination of primer from contacting one or more of the downstream printheads.

The blade composition used in the device could be made of materials such as elastomer or a ductile, pliable metal, as long as the blade can meet the system requirements for deflection. An elastomeric blade is lightweight and easy to move or clean but may not be as durable or resistant to wear as a metal blade. On the other hand, a metal blade may be more difficult to move or deflect.

The placement of a blade seal or multi blade system to prevent any droplets of primer or pre-treatment fluid from reaching downstream print heads jetting inks of the pigmented type to prevent printhead damage due to primer contamination of the downstream printheads is described in the present disclosure. In examples, a single blade can prevent primer fluid from reaching the marking printheads. Other examples incorporating a multiple blade implementation can also increase the life of the device should the first blade take a permanent set or become damaged. When the contamination prevention device is near or in contact with the transport device or media path, it effectively closes the airflow. In implementations, a non-contact, small gap can prevent blade deformation set and interference with the media if required for optimal system operation.

A method for preventing contamination from the use of a primer or precoat treatment can be employed by adjusting or rotating a blade holding device about a pivotable central axis to prevent droplets originating at a primer or precoat jetting station depositing a primer or precoat solution onto a print media, such as paper, from traveling or contaminating other printheads jetting ink containing colored pigments. In one non-contact example, a blade seal produces a small gap, from about 0.1 mm to about 0.5 mm between a blade tip and a print media to reduce or prevent the airflow from reaching downstream printhead stations. In other contacting examples, the blade seal can provide a discrete physical barrier to disrupt the path of any pretreatment or primer droplets. Adjusting the blade angle, blade length, blade thickness, working angle, interference, and blade material durometer to achieve maximum air flow closure without adding drag on the media to change its speed parameters. Implementations include the use of a multiblade assembly that can be rotated at a determined interval to maintain airflow closure should the blade take a permanent set or deformation. In other methods for preventing contamination in a printing system, the steps of the method can include coating a non-pigmented fluid, for example, a primer or precoat solution on at least a portion of a surface of a media with a primer dispensing printhead, transporting the coated media along a media path, placing a printhead contamination prevention device comprising an edge that spans across an entire width of the media path in proximity to the surface of the media, and blocking one or more droplets of non-pigmented fluid ejected from the a primer dispensing printhead that are not coated onto the surface of the media from moving along the media path. In examples, the edge of the contamination prevention device can include a continuous, solid blade edge. The edge of the printhead contamination prevention device can alternatively include a brush or otherwise segmented, intermittent, or non-continuous edge that forms the gap between the edge and the surface of the media. In examples, the gap is from about 0.1 mm to about 0.75 mm. Further steps of the method can include adjustments or processes as described herein, such as further adjusting the gap between the wherein the contamination prevention device. The adjustment can be accomplished by rotating, translating or otherwise moving one or more components of the contamination prevention device. The gap is configured to disrupt primer particles from moving between the location of the primer-dispensing printhead and one or more ink jet dispensing printheads. The edge of the contamination prevention device provides a means of disrupting airflow between the primer-dispensing printhead and one or more ink jet dispensing printheads to stop any airborne primer particles, droplets, or aerosolized droplets of primer from contacting the one or more ink jet dispensing printheads and causing crashing or contamination on or around the one or more ink jet dispensing printheads. In a primer jetting process, satellite particles entrained in airflow emanate from the jetting station upstream of the contamination prevention device are typically on the order of single-micron size, or from 1 μm to about 3 μm, the airflow being laminar particularly near the surface of the media path, or marker transport. Actual drops as intended are on the order of about 5 μm to about 15 μm in size. The densities of the aqueous ink and primer are similar and are typically in a range from about 1.05 to about 1.25 g/ml.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A printhead contamination prevention device, comprising:
a mounting fixture; and
a blade attached to the mounting fixture; and
wherein an angle of the mounting fixture and a position of the blade create a gap between a tip of the blade and a printing media.

2. The printhead contamination prevention device of claim 1, wherein:
the mounting fixture is rotatable to multiple angles about a central axis; and
the blade is movable.

3. The printhead contamination prevention device of claim 1, wherein at least a portion of an edge of the blade is non-continuous.

4. The printhead contamination prevention device of claim 1, wherein the printhead contamination prevention device is located between a primer dispensing system and at least one ink jetting printhead.

5. The printhead contamination prevention device of claim 4, wherein the primer dispensing system comprises a printhead.

6. The printhead contamination prevention device of claim 2, wherein an angle of the blade relative to the printing media is rotatable from about 15 degrees to about 35 degrees.

7. The printhead contamination prevention device of claim 1, wherein the gap between the tip of the blade and the printing media is from about 0.1 mm to about 0.75 mm.

8. The printhead contamination prevention device of claim 4, wherein a primer composition dispensed by the primer dispensing system comprises about 5% wt to about 40% wt of a salt in an aqueous solution based on a total weight of the aqueous solution.

9. The printhead contamination prevention device of claim 1, wherein the printing media is paper.

10. The printhead contamination prevention device of claim 2, wherein the blade is configured for linear translation along a side of the mounting fixture.

11. A printhead contamination prevention device, comprising:
a mounting fixture, rotatable to multiple angles about a central axis; and
a movable and deformable blade attached to the mounting fixture; and
wherein the movable blade is in contact with a printing media when the printing media passes below the printhead contamination prevention device.

12. The printhead contamination prevention device of claim 11, wherein the printhead contamination prevention device is located between a primer dispensing printhead and at least one ink jetting printhead.

13. The printhead contamination prevention device of claim 11, wherein an angle of the movable blade relative to the printing media is from about 15 degrees to about 35 degrees.

14. The printhead contamination prevention device of claim 11, wherein a tip of the movable blade contacts the printing media.

15. The printhead contamination prevention device of claim 12, wherein a primer composition dispensed by the primer dispensing system comprises about 5% wt to about 40% wt of a salt in an aqueous solution based on a total weight of the aqueous solution.

17. A method for preventing contamination in a printing system, comprising:
coating a non-pigmented fluid on at least a portion of a surface of a media with a primer dispensing printhead;
transporting the coated media along a media path;
placing a printhead contamination prevention device comprising an edge that spans across an entire width of the media path in proximity to the surface of the media;
forming a gap between the edge of the printhead contamination prevention device and the surface of the media; and
blocking one or more droplets of non-pigmented fluid ejected from the primer dispensing printhead that are not coated onto the surface of the media from moving along the media path.

18. The method for preventing contamination in a printing system of claim 17, wherein the edge of the printhead contamination prevention device further comprises a non-continuous edge.

19. The method for preventing contamination in a printing system of claim 17, wherein the gap is from about 0.1 mm to about 0.75 mm.

20. The method for preventing contamination in a printing system of claim 17, further comprising adjusting the gap between the surface of the media and the edge of the contamination prevention device.
